(19) United States
(12) Patent Application Publication
(10) Pub. No.: US 2003/0229846 A1
(43) Pub. Date: Dec. 11, 2003

(54) System and method for capturing digital data directly from an electronic device and processing the data into XML form on a computer chip

(76) Inventors: Anil Sethi, Weston, FL (US); Arulnambi Kaliappan, Weston, FL (US); Kenneth Scott Davis, Lauderhill, FL (US); Marc Edward Rubin, Reisterstown, MD (US); Terrence Egan, Melbourne, FL (US)

Correspondence Address: FENWICK & WEST LLP, SILICON VALLEY CENTER, 801 CALIFORNIA STREET, MOUNTAIN VIEW, CA, 94041, US

(21) Appl. No.: 10/242,360

(22) Filed: Sep. 13, 2002

Related U.S. Application Data
(60) Provisional application No. 60/386,388, filed on Jun. 7, 2002.

(51) Int. Cl. G06F 15/00

(52) U.S. Cl. 715/500; 715/508

(57) ABSTRACT

A method and system for capturing digital data directly from an electronic device's port and processing the data into extensible markup language (XML) form. The integration appliance is configured with desired templates and XML output destination information. A port driver captures the data flowing through the port on its way to the printer. The data is scanned and the data format is determined. The data is parsed into fields and data. The parsed data is scanned to determine the correct template to apply. The correct template is applied to the data to pull out fields and corresponding data. The fields and corresponding data is transformed to XML output. This XML output is sent to a predefined destination.

This application claims priority from U.S. Provisional Application Serial No. 60/386,388 filed Jun. 7, 2002. The entirety of that provisional application is incorporated herein by reference.

### BACKGROUND OF THE INVENTION

1. Field of the Invention

The present invention generally relates to systems and methods for capturing data, and more specifically, to systems and methods for capturing digital data from electronic devices for processing.

2. Related Art

Currently, the de facto method for sharing information amongst heterogeneous, distributed parties is to print a document onto paper, and share the paper. This works well if the consumer of such paper-based data is a person. However, it is not an efficient method for sharing data among computer applications, which cannot infer context from simple printed text. With computers performing ever increasing functions on behalf of people, a more efficient method of data sharing is needed.

The majority of prior solutions leverage a form of mimicking user input by integration software—typically sending data via the keyboard and terminal. For example, a process known as “screen scraping” allows software to mimic a user's interaction of screen inputs and perform data integration activities. However, for a variety of technological reasons, such data integration software has proved complex.

The traditional approach of accessing a computer's proprietary data is a proactive process of obtaining data in its native environment, at its source. Examples include using structured query language (SQL) application programming interfaces (APIs) for data stored in databases, rooting around file systems, or writing custom software for each data source. Although these proactive methods are effective, they are neither efficient nor universal approaches. They are not robust (i.e., custom software is often brittle) and are often co-dependent on detailed knowledge of the target systems.

Prior art solutions to the above-identified problem have involved electronic data interchange (EDI), file conversion, or manipulation of data to extensible markup language (XML) format. EDI relies on custom or proprietary software on both the sending and receiving systems, and relies on a proprietary network technology. File conversion requires that the conversion solution convert data from file format A to file format B. Thus, a source file is required. Where there is a closed system, or where source files are not easily available, conversion is difficult or impossible. Manipulation of data to an XML format is easily done when a database already has the data. The problem is obtaining the relevant data that can be transformed to XML format.

It is well known within the IT community that a universal solution to the computer integration problem is severely needed. Example uses of such an integration include, but are not limited to: allowing the intelligence community to instantly share available data across agencies interested in homeland security; providing the healthcare industry with the ability to easily share (secured) data among patient and allied healthcare workers; and providing an entity or individual with the ability to aggregate all their financial records, investments, and bank accounts.

### SUMMARY OF THE INVENTION

The present invention, referred to as the integration appliance, solves the above-described computer integration problem by providing a system and method for capturing digital data directly from an electronic device's port and processing the data into a specified format (e.g., XML), while allowing for the data to be used as it was originally intended (e.g., as in printing of the data by a connected printer). XML is a data format that serves as the universal interchange format between applications.

An embodiment of the present invention is used with a printer and a computer. The computer transmits data to the printer. During this transmission, the integration appliance gathers pre-specified data and converts it into XML format.

The present invention includes the following steps: the integration appliance is configured with desired templates and XML output destination information; a print action occurs; the port driver captures the data flowing through the port on its way to the printer, and passes the data to a virtual printer interface; the virtual printer interface scans the data, determines the format of the data, and passes the data to the appropriate language parser; the appropriate language parser parses the data into fields and data and loads the parsed data into a virtual printer runtime; an XML micro-engine scans the data from the virtual printer runtime and determines the correct template to apply; the XML micro-engine applies the correct template to the data to pull out fields and corresponding data; the virtual printer runtime sends the fields and corresponding data to the XML micro-engine, which creates XML data containing fields and corresponding data; this XML output is sent to the XML export interface; the XML export interface optionally adds a message envelope (e.g., a simple object access protocol (SOAP)) to the XML output to create an XML message; the XML export interface sends the XML message to the XML output destination; and the output destination site utilizes the XML output.

### BRIEF DESCRIPTION OF THE FIGURES

Additional advantages and novel features of the invention will be set forth in part in the figures that follow, and in part will become more apparent to those skilled in the art upon examination of the following or upon learning by practice of the invention.

FIG. 1 is a diagram illustrating how the integration appliance is used with a printer and a computer, in an embodiment of the present invention.

FIG. 2 is a picture of a integration appliance, in accordance with an embodiment of the present invention.

FIG. 3 is a diagram illustrating a system overview of the port processing architecture, in accordance with an embodiment of the present invention.

FIG. 4 is a flowchart illustrating a method overview, in an embodiment of the present invention.

FIG. 5 is a flowchart illustrating an example of the overview method, in accordance with an embodiment of the present invention.

FIG. 6 is a form illustrating an example of the HCFA 1500 form as completed and printed, in accordance with an embodiment of the present invention.

FIG. 7 is data illustrating an example of PCL data format.

FIGS. 8A and 8B are data illustrating XML fields and corresponding data, as sent to the XML export interface, in accordance with an embodiment of the present invention.

FIGS. 9A and 9B are data illustrating an XML message, consisting of the XML output and the ebXML/SOAP envelope, in accordance with an embodiment of the present invention.

FIGS. 10A and 10B are data illustrating an XML message consisting of the XML output and Web service SOAP message envelope, in accordance with an embodiment of the present invention.

FIG. 11 is a screen shot illustrating an XML message sent by email, in accordance with an embodiment of the present invention.

### DESCRIPTION OF THE INVENTION

Entities often wish to exchange data stored in one software application on one computer system (or generic electronic device), with a software application residing on another system. This often involves an intensive labor effort and use of integration software. Extensive software is usually required to extract data from a software application and export it in a form useable by another party.

The present invention provides a system and method for capturing digital data directly from an electronic device's port and processing the data into XML form, while allowing for the data to be used as it was originally intended, for example, printing of the data by a connected printer.

In one embodiment, a user loads the applicable device driver, plugs in the integration appliance between the computer and the printer (or any peripheral device), and prints a document using a software application. The integration appliance listens for data sent through the applicable port, extracts data fields for the particular form type from the print stream, creates an XML file of the extracted data, and sends this XML file to an XML consuming application. In this way, a print event from one application now also produces an XML file for use by another user or any interested computer software application.

In another embodiment, the present invention plugs into the data port of any electronic device, and exports the data in any type of preferred data format (e.g., ASCII, XML).

Advantages and Potential Uses

The present invention has at least the following advantages and potential uses. The present invention can utilize data exchanges that take place at a non-real-time speed. Such transactions can be useful even if they take hours or days, as long as the data is exchanged within a reasonably timely manner. For example, it is acceptable to update a patient's health records before the next appointment (which may be days away), or update bank records within a 24 hour period. Transactions related to these non-real-time services can be used with the present invention. In addition, transactions which are currently printed to paper are suited to be exported to XML.

An increasing number of software applications contain integration engines which allow the processing of XML files as imports into their applications' databases. Thus, one embodiment of the present invention creates XML files where otherwise there would be no XML file for such integration engines to consume and convert. Further, the XML file is created with little or zero human intervention. Thus, no significant manual labor to configure parameters within integration engines is required.

One embodiment of the present invention utilizes pre-configured XML templates for specific uses. For example, two of the emerging Health Insurance Portability & Accountability Act of 1996 (HIPAA) healthcare transactions, the Health Care Financing Administration (HCFA) 1500 form and the hospital UB92 form, can be pre-loaded as templates into the device. Another example would be the use of daily printed reports from a security agency and resulting XML files as the solution to populate the databases of another security agency (e.g., uses in “homeland security”).

Features

The present invention includes at least the following features: a novel computer chip that creates XML form data to be used for data integration by software programs; a novel chip that, with its surrounding circuitry, serves as an Ethernet Card outputting XML data; hardware-based encryption of XML files; creation of a language parser in hardware (e.g., a PCL parser); a language (e.g., PCL) to XML conversion in hardware; capability to use Internet protocols (e.g., Simple Mail Transfer Protocol (SMTP), HyperText Transfer Protocol (HTTP), File Transfer Protocol (FTP), and Simple Object Access Protocol (SOAP)) to send XML files in hardware; detection and/or recognition of printable documents (e.g., reports and forms) in hardware; recognition of distinct printer protocols (e.g., PCL, Escape Sequences (ESC), Postscript); capability of extracting text fields from one language for conversion into XML fields, in hardware; converting Microsoft Windows™ print jobs from their native form (e.g., pictures of text characters or Glyphs), into actual American Standard Code for Information Interchange (ASCII) characters; intercepting data streams in hardware, and operating as a port sniffer for conventional data ports like serial, parallel, USB, and network ports; and building the XML chip into a black box, as well as into a printer, for direct output of print jobs as XML files.

System Overview

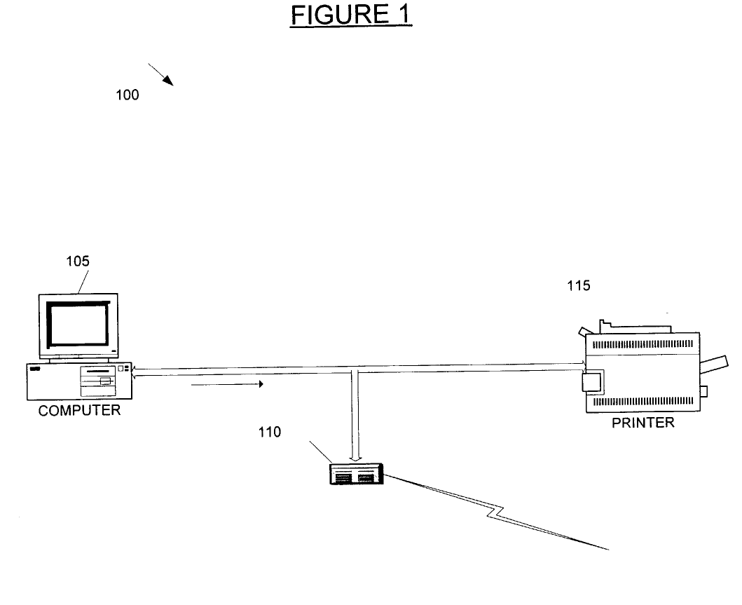

FIG. 1 is a diagram illustrating how the integration appliance is used with a printer and a computer, in an embodiment of the present invention. A computer 105 transmits data to a printer 115. During this transmission, a integration appliance 110 gathers pre-specified data and converts it into XML format.

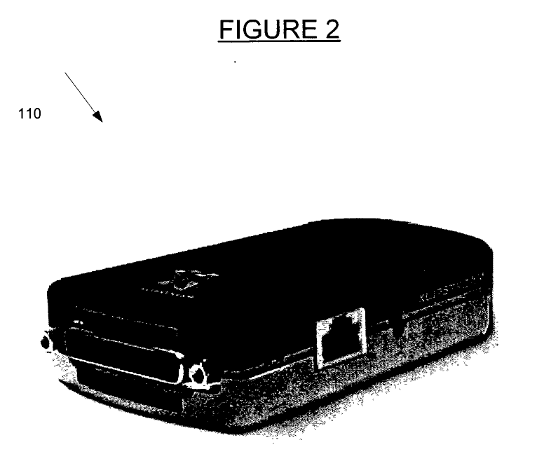

FIG. 2 is an example picture of an integration appliance, in accordance with an embodiment of the present invention.

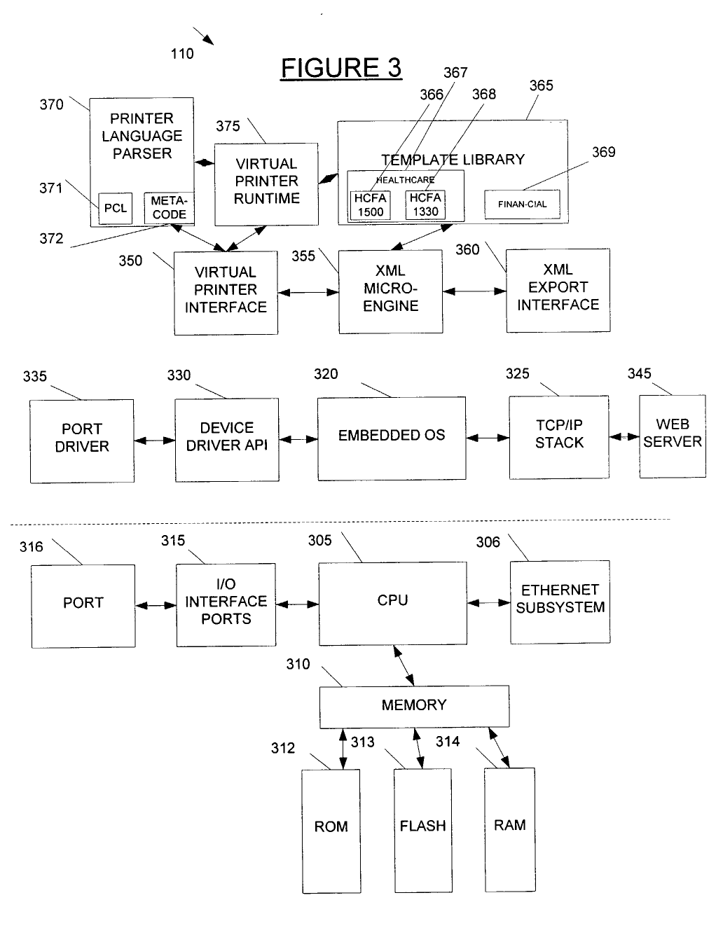

FIG. 3 is a block diagram illustrating a system overview of the integration appliance architecture, in accordance with an embodiment of the present invention. The integration appliance 110 includes the following components.

CPU. The central processing unit (CPU) 305 is a “soft CPU”, or an actual CPU chip. The CPU is the computational and control unit that interprets and executes instructions, and transfers information to and from other resources.

Memory Modules. The memory modules 310 can include different types of memory, including, but not limited to, random access memory (RAM) 314, read only memory (ROM) 312, and flash memory 313. The memory modules have different characteristics (e.g., read-only) or functions (e.g., cache). The RAM is semiconductor-based memory that can be read and written by the CPU or other hardware devices. The storage locations in the RAM can be accessed in any order. RAM is volatile memory (i.e., memory that loses its data when power is turned off) that can be written to as well as read. The ROM is a semiconductor circuit serving as a memory that contains instructions or data that can be read but not modified. The flash memory is a type of nonvolatile memory that must be erased in blocks, as compared with one byte at a time. Because of its block-oriented nature, flash memory is commonly used as a supplement to or replacement for hard disks in portable computers. Flash memory cannot be practically used as main memory (e.g., RAM) because a computer needs to be able to write to memory in single-byte increments.

I/O Interface Ports. The input/output (I/O) interface ports 315 are implementations of different interfaces, through which data is transferred. The I/O interface ports appear to the CPU as one or more memory addresses that the CPU can use to send or receive data. The I/O interface ports include, but are not limited to, a parallel port, a serial port, and a universal serial bus (USB) port. A parallel port is the I/O connector for a parallel interface device. For example, printers are often plugged into a parallel port. A serial port is an I/O location (channel) that sends and receives data to and from the CPU one bit at a time. The serial port is used for serial data communication and interfaces with devices, such as modems. The USB port is a serial bus that connects peripherals (e.g., the printer) to the CPU. The USB port is designed to support the ability to automatically add and configure new devices and the ability to add such devices without having to shut down and restart the system (i.e., hot plugging).

Embedded OS. The embedded operating system (OS) 320 is the software the controls the allocation and usage of the hardware components, such as memory modules 310, CPU 315, and peripheral devices (e.g., a printer). The software components of the integration appliance run as applications in the embedded O.S. The OS 320 provides a transmission control protocol/Internet protocol (TCP/IP) stack 325 is a set of TCP/IP protocols that is used to support the network connectivity required by the integration appliance. The OS also provides a device driver application programming interface (API) 330 that is used to write port driver 335 for the I/O interface ports. The port drivers control the I/O interface ports and capture data flowing through the ports and make it available to the software components that are executing as applications in the OS. The port drivers handle port specific features, and thus the OS is freed from the burden of having to understand and support the needs of the I/O interface ports. There is a parallel port driver to correspond to the parallel port, a serial port driver to correspond to the serial port, and a USB port driver to correspond to the USB port.

Virtual Printer Interface. The integration appliance captures a print stream heading to a printer from a computer or other electronic device. The first step in the processing of this print stream by the integration appliance is the “parsing” of the printer language markup to break it down into printer commands and the actual data. The virtual printer interface 350 performs this task.

Printer Language Parser. The virtual printer interface 350 decodes the specific printer language being used in the print stream and loads the specific printer language parser 370 corresponding to the print stream language. The parser then receives the print stream and converts it into an interpreted set of commands and data. These commands and data are fed into the virtual printer runtime 375, which reconstitutes the data back into a representation of the original print page, one page at a time. The data is now available for querying by the XML microengine 355, which performs the next steps in the processing of the captured data.

XML Microengine. The XML microengine 355 uses the concept of templates (explained below) to understand and add “context” (semantics) to the data parsed from the print stream by the virtual printer interface. It then marks up the data in XML format as specified by the applicable template. This XML stream is then passed on to the XML export interface 360, which sends the data on to its configured destination.

In order to understand the functions of the XML microengine 355 in more detail, one needs to understand the logical nature of the data processed by the integration appliance. The integration appliance processes data that can be described as: printable transactions or events; structured information composed of a collection of “fields” (e.g., names, and corresponding values); logical groupings (e.g., packets) of fields called “forms”; physically described by a well-defined “printer language” or “markup”.

The virtual printer interface is responsible for “decoding” or “parsing” the data contained inside the print stream in the printer language, while the XML microengine understands and adds the semantics of this data and produces the XML that is exported to an XML consumer application. Thus, the three main functions of the XML microengine are form recognition, fields recognition and extraction, and output markup.

Form Recognition recognizes the logical grouping or “form”, given the raw data, as one that the integration appliance knows how to break down into fields and thus add context to the blob of data extracted from the printer markup.

Fields Recognition and Extraction makes it possible to recognize fields and extract them from the raw data obtained from the print stream if one knows the form type and hence the field definitions (name of field, how the field can be extracted from the form data, XML markup specifications, and any additional contextual information like data type, etc.) of that form.

Output markup is when extracted form data is marked up in the required integration appliance output format, which is XML.

XML Export Interface. The XML file generated by the XML microengine is transported to a configured destination address (e.g., URL, email address) by the XML export interface 360. The XML Export Interface is aware of communication protocols, such as simple mail transfer protocol (SMTP) and hypertext transfer protocol (HTTP), and sends the XML data to a destination address using the associated protocol. Optionally, the XML export interface can also add configured message envelope and headers (e.g., SOAP/ebXML, Web service interfaces) to the original XML output, and send the complete message to its destination.

Template Library. An optional module that resides off the device, in a separate computer, is the template library 365. A set of template designer applications are the tools that can be used to create and maintain form templates. The templates are stored in the centralized template library, if one exists in the installation. The template library (P), a set of form templates, can be maintained off the integration appliance. This library is accessed by the device when it needs to pull down new form templates for use by the XML microengine. Applications that generate and maintain form templates use this library as their storage location. Template libraries can be per installation, per geographic location, per facility or organized in any hierarchy as deemed fit by the system administrator. For example, template libraries could include a healthcare template category 367 and a financial template category 369. Optionally, the template categories can include form templates. For example, the healthcare template category can include templates for health care forms HCFA 1500 form 366 and HCFA 1330 form 368.

Template designer tools help in the authoring and maintenance of form templates stored in the template library, or on board the integration appliance, if a library does not exist.

Form Template. A form template is a integration appliance design concept that abstracts all the information necessary for the XML microengine to recognize a form, and recognize and extract form fields from the raw data extracted from a print stream. It also contains the output markup specification for that form. Form templates are generated and maintained using tools that reside off the integration appliance, and can be organized into a library of templates for a given integration appliance installation. The XML microengine running on the integration appliance utilizes form templates to perform its functions of forms recognition, fields recognition and extraction, and output markup.

The logical structure of a form template is show below:

<form.template name = “...” type = “...” version = “...”>

<form.recognition>

...spec...

</form.recognition>
<output>

...output markup spec...

</output>
<form.fields>

<field name = “...”>

<field.recognition>

...spec...

</field.recognition>
<output>

...output markup spec...

</output>

</field>
<field>

...

</field>
...

</form.fields>

</form.template>

The above XML structure does not represent the actual format of a integration appliance form template. It is merely a representation to show the kind of information that may be contained in an actual template.

Web Server. A Web server 340 running on the integration appliance provides access to the configuration settings, so that the integration appliance can be remotely configured and administered through ordinary Web browser clients. Specifying configuration settings, such as output destination addresses, message envelope specifications, and adding and changing template files can be accomplished through this administration interface.

Method Overview

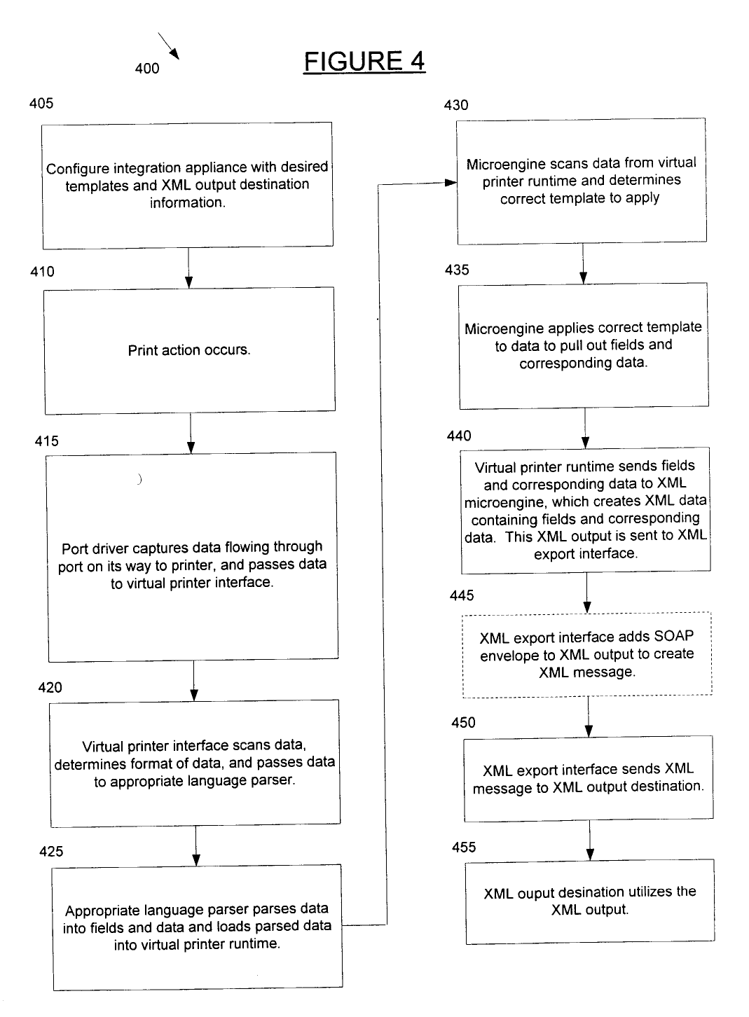

FIG. 4 is a flowchart illustrating a method overview 400, in an embodiment of the present invention.

In step 405, the integration appliance 110 is configured with desired templates and XML output destination information. The desired templates can include, but are not limited to a health care template, a financial services template, a security services template, a manufacturing template, a banking template, an insurance template, and multiple government (e.g., state, local, federal) templates. Thousands of templates are possible. In addition, each template category can contain a few form templates, or up to and more than thousands of form templates. For example, the health care template category can include the following forms: HCFA 1500, HCFA 1330, and UB 92. In step 410, a print action occurs. In step 415, the port driver captures the data flowing through the port on its way to the printer, and passes the data to the virtual printer interface. In step 420, the virtual printer interface scans the data, determines the format of the data, and passes the data to the appropriate language parser. The language parsers include, but are not limited to, a PCL language parser, an XML language parser, a Metacode language parser, and an AFP language parser. In step 425, the appropriate language parser parses the data into fields and data and loads the parsed data into the virtual printer runtime. In step 430, the microengine scans the data from the virtual printer runtime and determines the correct template to apply. In step 435, the microengine applies the correct template to the data to pull out fields and corresponding data. Instep 440, the virtual printer runtime sends the fields and corresponding data to the XML microengine, which creates XML data containing fields and corresponding data. This XML output is sent to the XML export interface. In step 445, the XML export interface adds a SOAP envelope to the XML output to create an XML message. Different types of message envelopes can be added, including but not limited to SOAP for Web services, and ebXML. There may also be no added message envelope or header. In step 450, the XML export interface sends the XML message to the XML output destination. In step 455, the output destination site utilizes the XML output.

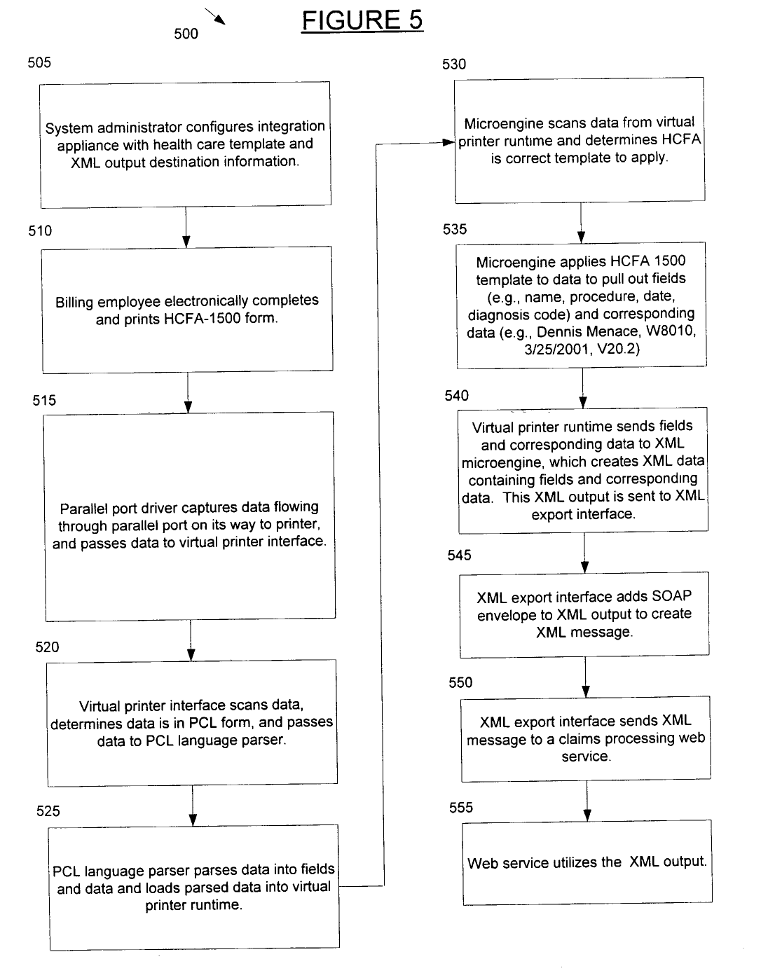

FIG. 5 is a flowchart illustrating an example of method 400, in accordance with an embodiment of the present invention.

In the prior art, a healthcare claim is submitted to an insurance company by entering data into a standard form, printing the form, and mailing it to an insurance company for processing. In the present invention, the integration appliance is connected using parallel cables to the parallel port of the computer generating the claims forms, and the parallel interface of the printer printing these forms. A network cable plugged into the integration appliance provides network connectivity.

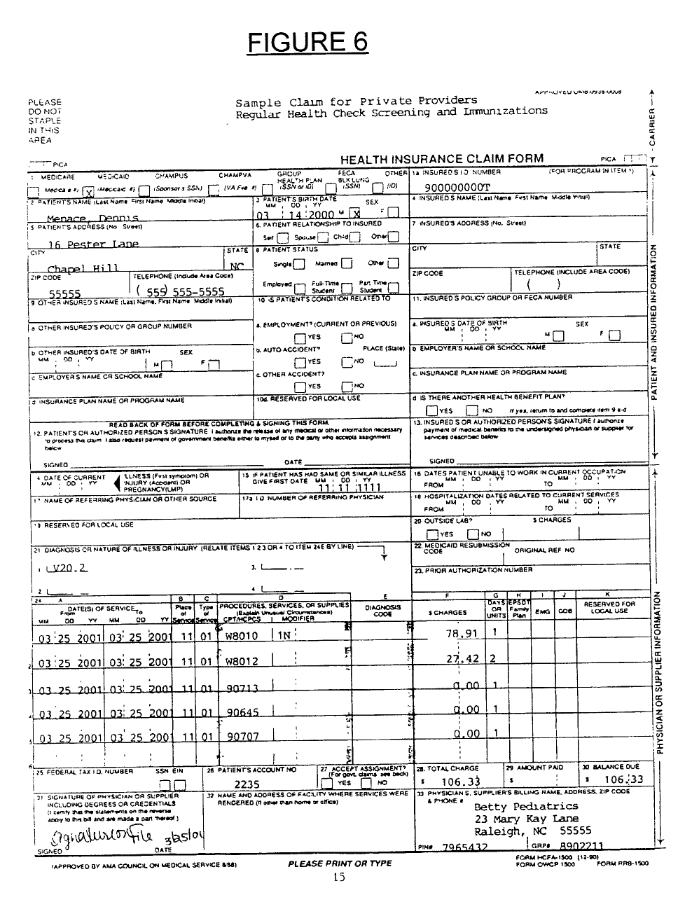

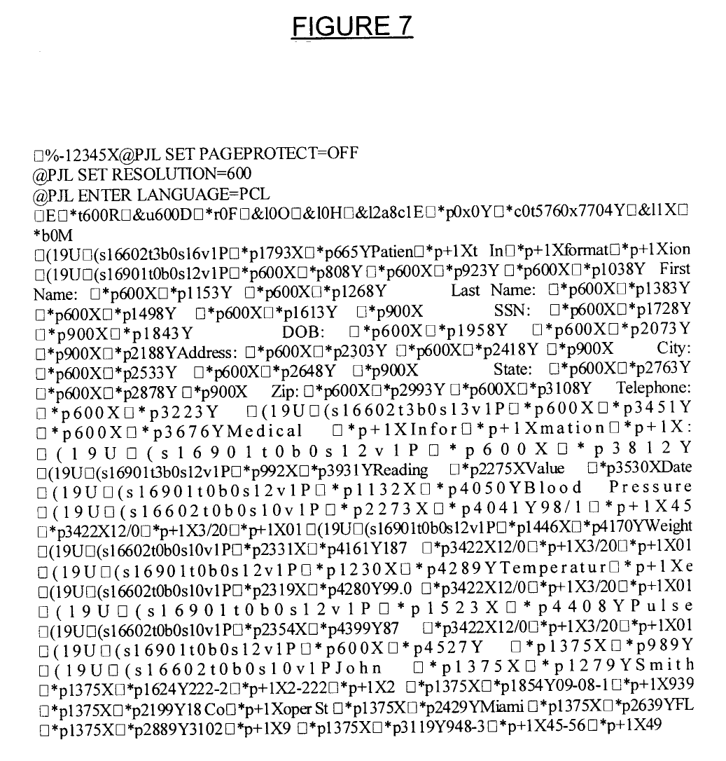

In step 505, the system administrator configures the integration appliance with the health care template that includes forms HCFA 1500 and HCFA 1330. In step 510, the billing employee electronically completes and prints the HCFA 1500 form. FIG. 6 is a form illustrating an example of the HCFA 1500 form as completed and printed, in accordance with an embodiment of the present invention. In step 515, the parallel port driver captures the data flowing through the parallel port on its way to the printer and passes the data to the virtual printer interface. In step 520, the virtual printer interface scans the data, determines the data is in PCL form, and passes the data to the PCL language parser. The virtual printer interface determines that the data is in PCL form by searching for key data streams or commands that indicate a specific language (e.g., “PCL start”). FIG. 7 illustrates an example of PCL data format. In step 525, the PCL language parser parses the data into fields and data and loads the parsed data into the virtual printer runtime. In step 530, the microengine scans the data from the virtual printer runtime and determines that the HCFA 1500 is the correct template to apply. This is done, for example, by searching the data for key words that appear in the HCFA 1500 form template (e.g., “HCFA 1500”). If the key words appear, the HCFA 1500 template is applied. If the HCFA 1500 key words do not appear, the microengine searches for key words from the next template (e.g., HCFA 1330).

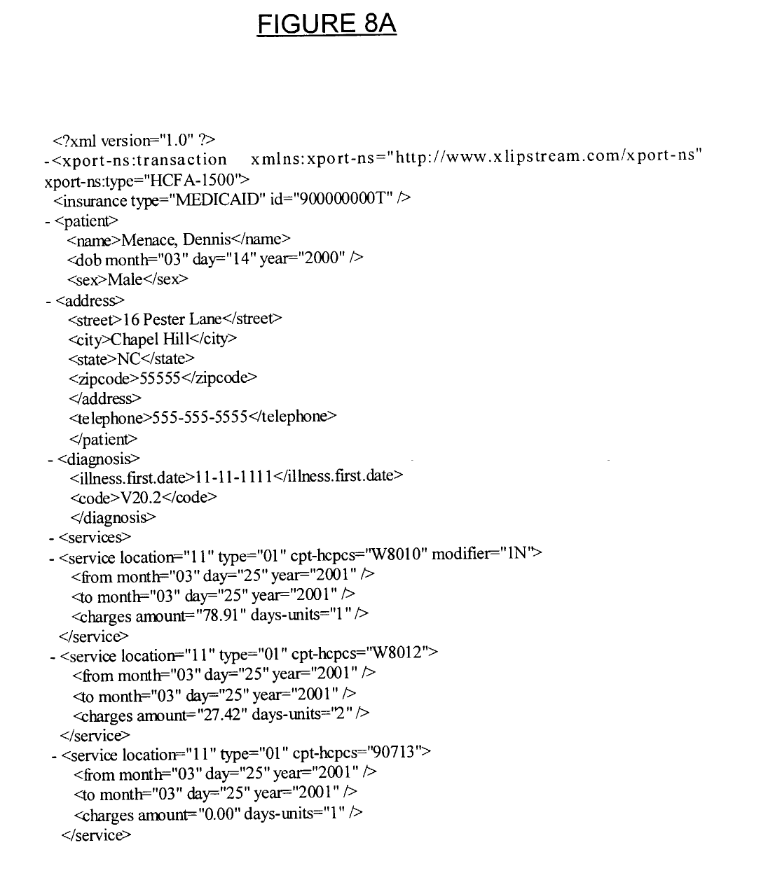

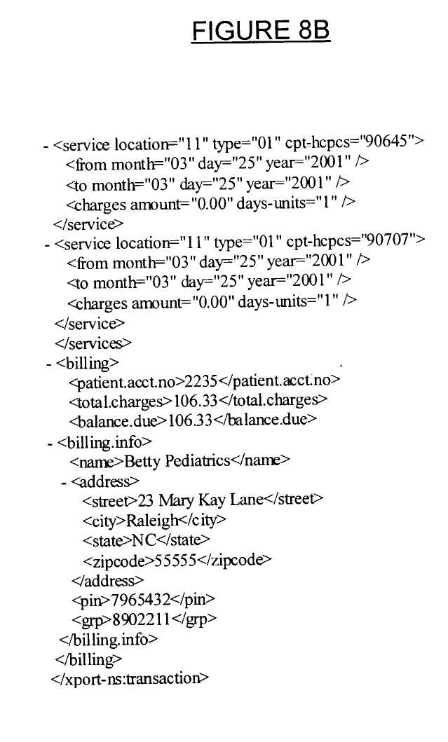

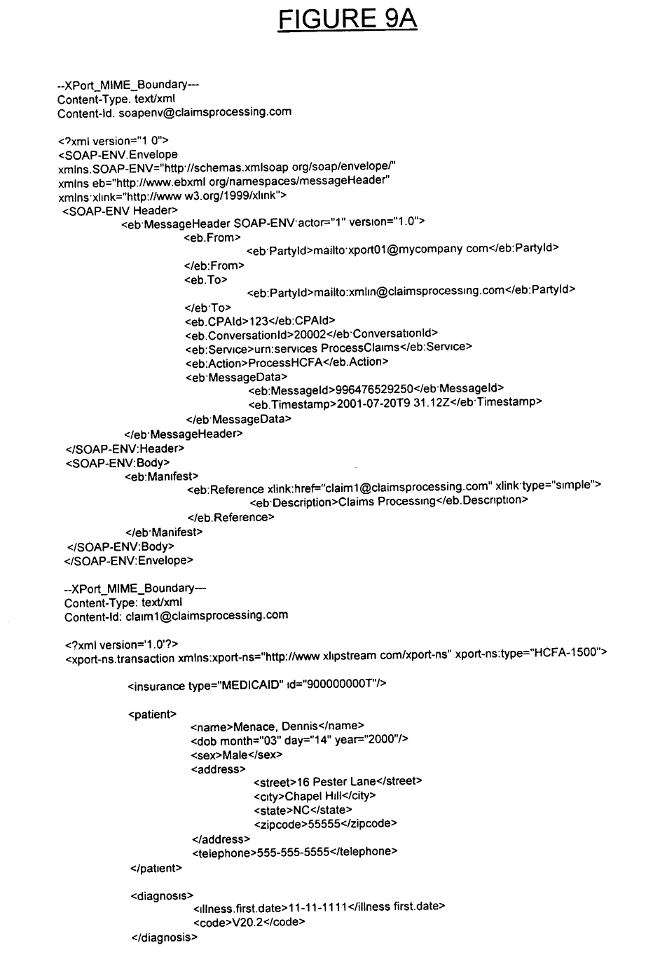

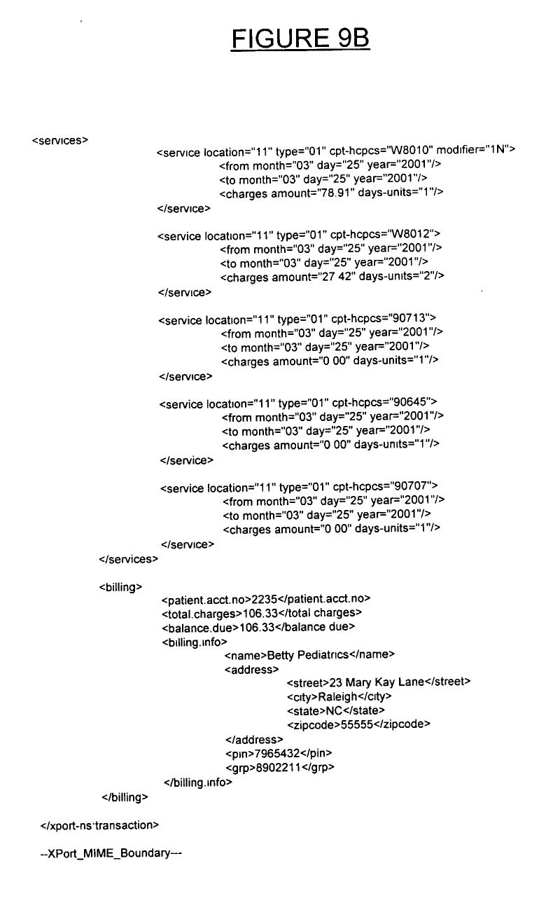

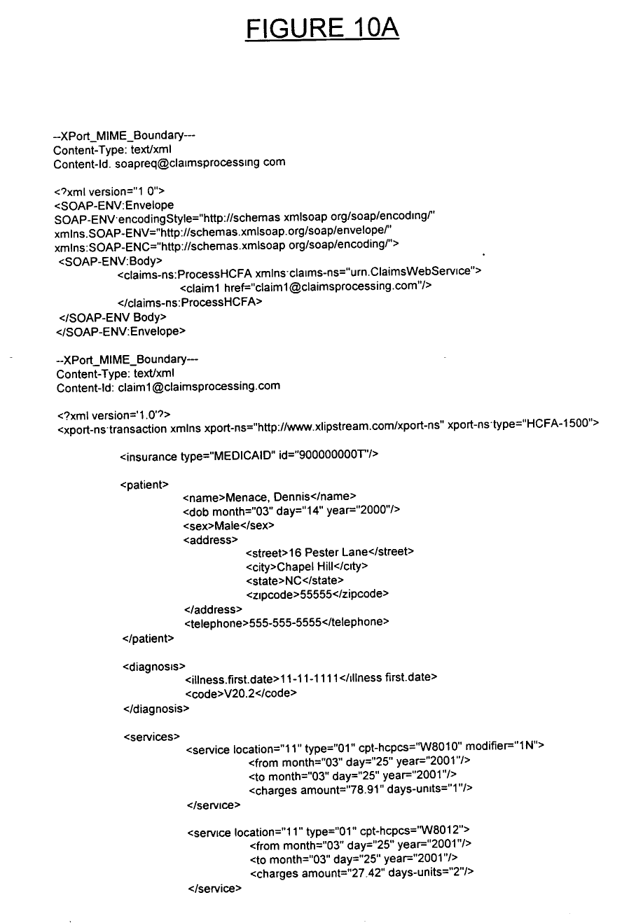

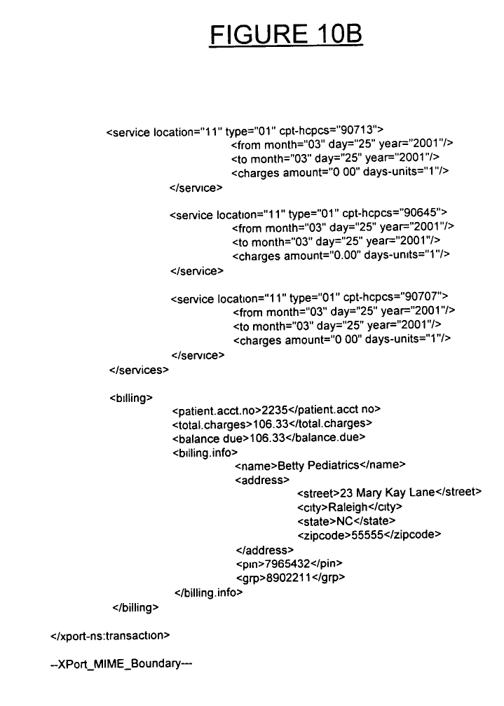

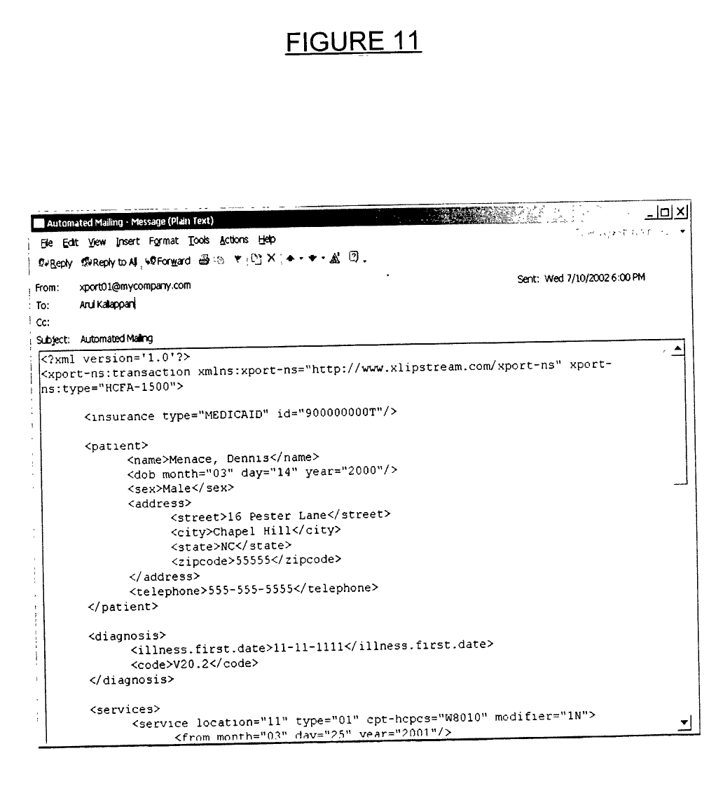

In step 535, the microengine applies the HCFA 1500 template to the data to pull out fields (e.g., name, procedure, date, diagnosis code) and corresponding data (e.g., Dennis Menace, W8010, Mar. 25, 2001, V20.2). In step 540, the virtual printer runtime sends fields and corresponding data to XML microengine, which creates XML data containing fields and corresponding data. This XML output is sent to the XML export interface. FIGS. 8A and 8B are data illustrating XML fields and corresponding data, as sent to the XML export interface, in accordance with an embodiment of the present invention. In step 545, the XML export interface adds a SOAP message envelope to the XML output to create an XML message. FIGS. 9A and 9B are data illustrating an XML message, consisting of the XML output and the SOAP message envelope, in accordance with an embodiment of the present invention. In this example, a Web service is the configured destination of the XML output. FIGS. 9A and 9B display the SOAP message in the first part of the message, with the message body referencing the XML output. FIGS. 10A and 10B are data illustrating another SOAP message, in accordance with another embodiment of the present invention. The Web service SOAP of FIGS. 9A and 9B is only one example of a message envelope and header that can be added to the XML output. The present invention can be configured to use different message envelopes and headers depending on the requirements of the destination of the XML output. For example, if the XML output is sent to an e-business email interface for processing, the user can configure the present invention to use ebXML headers in the SOAP envelope, as illustrated by FIGS. 10A and 10B. In step 550, the XML export interface sends the XML message to a Web service. In step 555, the Web service utilizes the XML output. In another embodiment of the present invention, the XML message can be sent by email to a designated email address. FIG. 11 is a screen shot illustrating an XML message sent by email, in accordance with an embodiment of the present invention.

### EXAMPLE IMPLEMENTATIONS

The present invention (i.e., the system 100 and 110 and any parts or functions thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system includes one or more processors. The processor is connected to a communication infrastructure (e.g. a communications bus, cross-over bar, or network). Various software embodiments are described in terms of this exemplary computer system. After reading this description, it will become apparent to a person skilled in the relevant art(s) how to implement the invention using other computer systems and/or architectures.

In this document, the terms “computer program medium” and “computer usable medium” are used to generally refer to media such as a removable storage drive, a hard disk installed in hard disk drive, and signals. These computer program products provide software to the computer system. The invention is directed to such computer program products.

In an embodiment where the invention is implemented using software, the software may be stored in a computer program product and loaded into the computer system using a removable storage drive, a hard drive or a communications interface. The control logic (software), when executed by the processor, causes the processor to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Conclusion

The present invention is described in terms of the above embodiments. This is for convenience only and is not intended to limit the application of the present invention. In fact, after reading the description of the present invention, it will be apparent to one skilled in the relevant arts how to implement the present invention in alternative embodiments.

In addition, it should be understood that FIGS. 1-11 described above, which highlight the functionality and advantages of the present invention, are presented for example purposes only. The architecture of the present invention is sufficiently flexible and configurable, such that it may be utilized in ways other than that shown in FIGS. 1-11.

What is claimed is:

1. A method for capturing digital data directly from an electronic device's port and processing the data into a specified output format, comprising:
capturing data flowing through a computer port;
determining a data format of the data transmitted via the computer port;
identifying a parser appropriate for the data format;
parsing the data using the identified parser;
determining a template to apply to the parsed data;
applying the template to the parsed data to identify at least one field and corresponding data for each of the at least one field; and
transforming the field and corresponding data into the specified output format.

2. The method of claim 1, wherein the data transmitted via a computer port is destined for at least one of a group selected from:
a printer; and
an email destination.

3. The method of claim 1, wherein the data format is at least one of a group selected from:
printer control language (PCL);
metacode; and
advanced function printing (AFP).

4. The method of claim 1, wherein the template to apply is selected from at least one of a group consisting of:
a healthcare template category;
a financial services template category;
a security services template category;
a manufacturing template category;
a banking template category;
an insurance template category; and
a government template category.

5. The method of claim 1, wherein the template category comprises at least one form.

6. The method of claim 1, further comprising:
adding a message envelope to the specified output format.

7. The method of claim 1, further comprising:
sending the specified output format to a predetermined destination.

8. A computer program product comprising a computer usable medium having control logic stored therein for causing a computer to capture digital data directly from an electronic device's port and process the data into a specified output format, comprising:
first computer readable program means for capturing data transmitted via a computer port;
second computer readable program means for determining a data format of the data transmitted via the computer port;
third computer readable program means for identifying a parser appropriate for the data format;
fourth computer readable program means for parsing the data using the identified parser;
fifth computer readable program means for determining a template to apply to the parsed data;
sixth computer readable program means for applying the template to identify at least one field and corresponding data for each of the at least one field; and
seventh computer readable program means for transforming the field and corresponding data into the specified output format.

9. The computer program product of claim 8, further comprising:
eighth computer readable program means for adding a message envelope to the specified output format.

10. The computer program product of claim 8, further comprising:
ninth computer readable program means for sending the specified output format to a predetermined destination.

11. A system for capturing digital data directly from an electronic device's port and process the data into a specified output format, comprising:
means for capturing data transmitted via a computer port;
means for determining a data format of the data transmitted via the computer port;
means for identifying a parser appropriate for the data format;
means for parsing the data using a the identified parser;
means for determining a template to apply to the parsed data;
means for applying the template to pull out at least one field and corresponding data for each of the at least one field; and
means for transforming the field and corresponding data into a specified output format.

12. The system of claim 11, further comprising:
means for adding a message envelope to the specified output format.

13. The system of claim 11, further comprising:
means for sending the specified output format to a predetermined destination.

14. The method of claim 1, wherein the specified output format is extensible markup language (XML).

15. The system of claim 8, wherein the specified output format is extensible markup language (XML).

16. The system of claim 11, wherein the specified output format is extensible markup language (XML).
